(19) United States
(12) Patent Application Publication
(10) Pub. No.: US 2008/0232230 A1
(43) Pub. Date: Sep. 25, 2008

(54) Joining structure of a disc medium and a multifunctional card

(75) Inventor: Meng-Hsun Hsieh, Taipei (TW)

Correspondence Address: TROXELL LAW OFFICE PLLC, 5205 LEESBURG PIKE, SUITE 1404, FALLS CHURCH, VA, 22041, US

(73) Assignee: POWER MEDIA CD TECH INTERNATIONAL CO., LTD.

(21) Appl. No.: 11/727,195

(22) Filed: Mar. 23, 2007

(51) Int. Cl. G11B 3/70

(52) U.S. Cl. 369/272.1

(57) ABSTRACT

A joining structure of a disc medium and a multifunctional card, the main feature of which is to provide a multifunctional card adhered to one side of a disc medium, wherein the multifunctional card having a hole with a diameter no less than that of a mounting hole of the disc medium. Besides, after the disc medium and the multifunctional card are joined, the thickness of the joining structure is 0.7-1.2 mm, so that it can be carry-on and has no influence on the playing of the disc medium in a disc medium player.

### BACKGROUND OF THE INVENTION

1. Field of the Invention

The present invention relates to a joining structure of a disc medium and a multifunctional card and, more particularly, to a joining structure of a disc medium and a multifunctional card which are adhered.

2. Description of the Prior Art

Please refer to FIGS. 6 and 7. In recent times, people own more than one multifunctional card (5), such as a credit card, a smart card, a financial card, or a health insurance card. People carry various cards in their purses or small bags and use them in different situations.

Besides, music and video become so popular that various disc media (6) are provided in the market. Semi-translucent plastic covers are invented for protecting the disc media from damaging during transportation. People can carry the disc media without worrying about the possibility of damaging the disc media after inserting the disc media into the covers. Actually, a disc medium is provided with a mounting hole (61) in the center with a diameter of 14.5-15.5 mm by which the disc medium (6) can be put on a disc medium player.

If people carry various disc media (6) and various multifunctional cards (5) in a wallet at the same time, it will be difficult for them to take out certain one of the disc media (6) or the multifunctional cards (5). Besides, for the multifunctional cards (5) and the disc media (6) occupy certain space, people carrying the multifunctional cards (5) or disc media (6) have less space to carry other items with themselves. Moreover, people also may have disordered space when carrying various disc media (6) and the multifunctional cards (5).

In order to improve the above-stated disadvantages to provide a joining structure of a disc medium and a multifunctional card, the inventor had the goal to try and develop the present invention after long and difficult research to solve the problem of disordered space.

### SUMMARY OF THE INVENTION

The main object of the present invention is to provide a joining structure of a disc medium and a multifunctional card, wherein the disc medium is adhered with the multifunctional card.

In order to achieve the above object, the technical feature of the present invention is to provide a hole with a diameter larger than 15 mm in the center of the multifunctional card with a thickness of 0.2-0.4 mm.

Besides, the hole of the multifunctional card and the mounting hole of the disc medium are superposed at the center, wherein the hole is with a diameter larger than 15 mm and the mounting hole is with a diameter of 14.5-15.5, so that the multifunctional card can be attached to one side of the disc medium and has no influence on the readable part of the disc medium. Thereby, both the disc medium and the multifunctional card can independently perform their original functions without interfering with each other and can be carry-on.

Furthermore, the length of the diagonal line of the multifunctional card according to the present invention is equal to 120.5 mm or less.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is a schematic view of the multifunctional card in a joining structure of a disc medium and a multifunctional card according to the present invention.

FIG. 2 is a schematic view of the disc medium in a joining structure of a disc medium and a multifunctional card according to the present invention.

FIG. 3 is a top view of a joining structure of a disc medium and a multifunctional card according to the present invention, wherein the disc medium and the multifunctional card are joined.

FIG. 4 is a sectional view of a joining structure of a disc medium and a multifunctional card according to the present invention, wherein the disc medium and the multifunctional card are joined.

FIG. 5 is a sectional view of a joining structure of a disc medium and a multifunctional card according to the present invention, wherein the disc medium and the multifunctional card are joined by an adhesive layer.

FIG. 6 is a top view of a conventional multifunctional card.

FIG. 7 is a top view of a conventional disc medium.

### DETAILED DESCRIPTION OF THE PREFERRED EMBODIMENTS

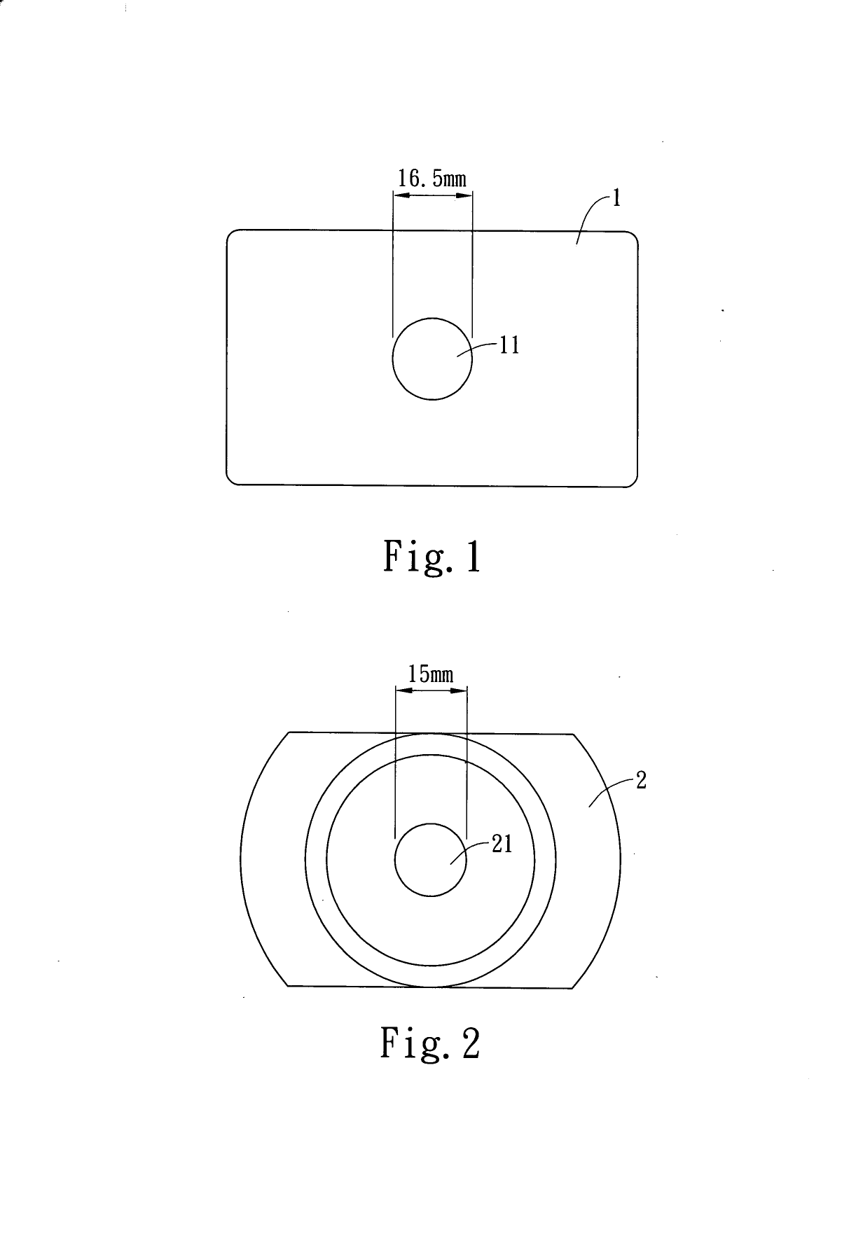

In order to achieve the purpose of being conveniently carry-on, as shown in FIGS. 1 and 2, the present invention providing a joining structure of a disc medium and a multifunctional card comprises a multifunctional card (1) and a disc medium (2), wherein the multifunctional card is provided with a hole (11) with a diameter larger than 15 mm and a diagonal line equal to 120.5 mm or less.

Besides, the disc medium (2) is provided with a mounting hole (21) with a diameter of 14.5-15.5 mm.

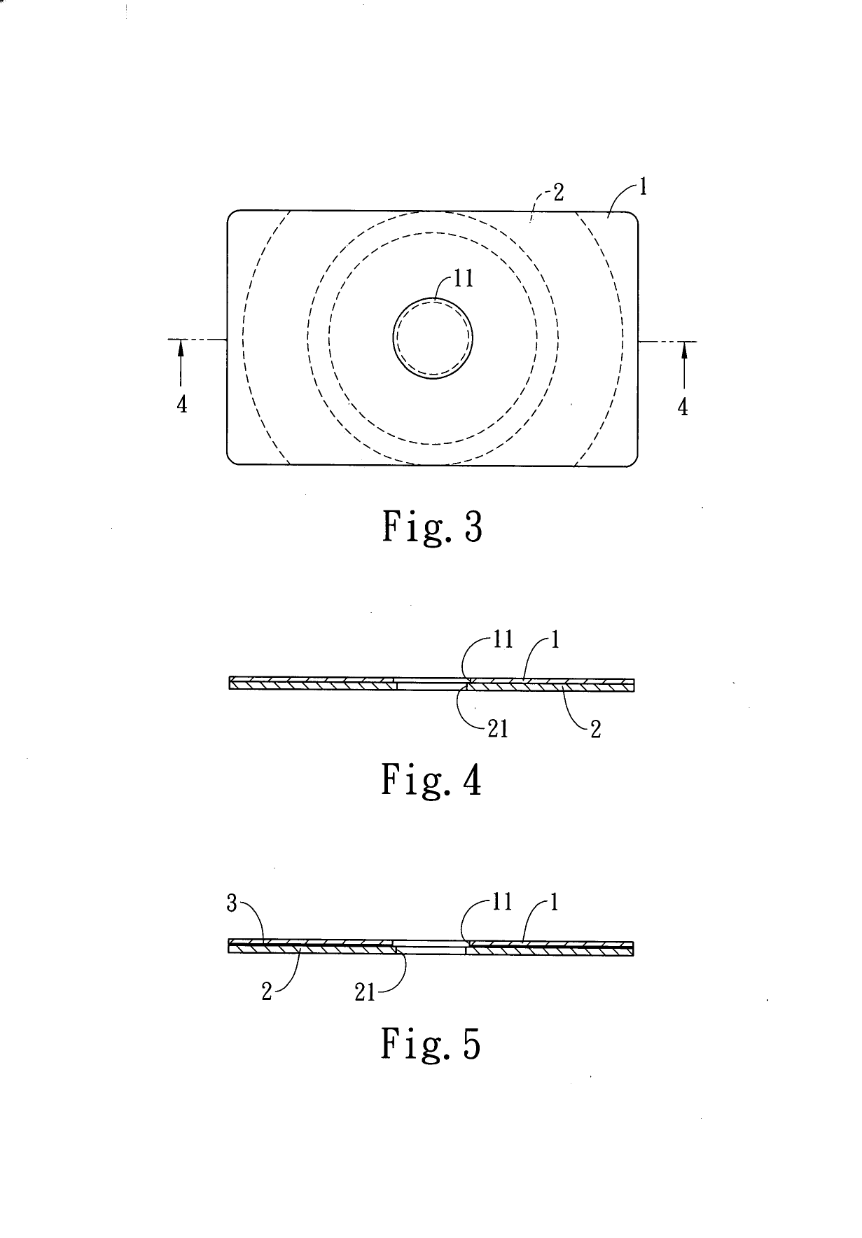

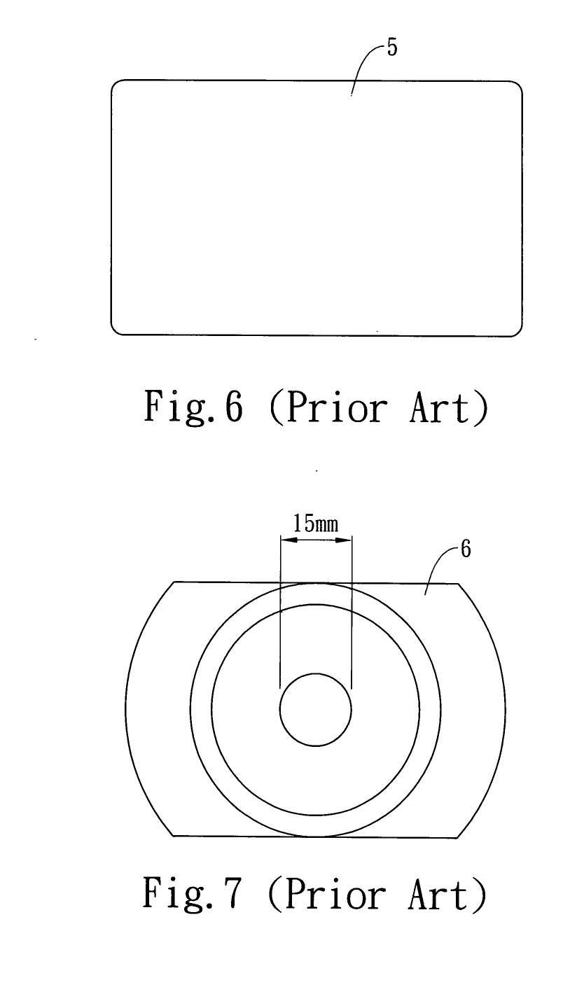

As shown in FIG. 3 to 5, the disc medium (2) is attached to one side of the multifunctional card (1) to make the hole (11) and the mounting hole (21) superposed at the center. The hole (11) is with a diameter larger than 15 mm and the mounting hole (21) is with a diameter of 14.5-15.5 mm, so the diameter of the hole (11) is larger than that of the mounting hole (21). Thereby, the joining structure of a disc medium and a multifunctional card according to the present invention will have no influence on the readable part of the disc medium when the joining structure is played in a disc medium player.

Besides, a standard disc medium is usually with a thickness of 0.54-0.65 mm while a standard multifunctional card is usually with a thickness of 0.85-0.9 mm. In order to meet the specification requirement of the thickness of a disc medium to be played in a present disc medium player, in the present invention, the disc medium (2) is with a thickness of 0.5-0.7 while the multifunctional card (1) is with a thickness of 0.2-0.4 mm, so that the total thickness of the combination of the disc medium (2) and the multifunctional card (1) is 0.7-1.1 mm.

Moreover, in order to join the disc medium (2) and the multifunctional card (1) securely, an adhesive layer (3) is provided between the disc medium (2) and the multifunctional card (1) and the adhesive layer is with a thickness of 0.01-0.1 mm. Thereby, the total thickness of the combination of the disc medium (2) and the multifunctional card (1) together with the adhesive layer (3) is 0.71-1.2 mm. Accordingly, the combination of the disc medium (2) and the multifunctional card (1) according to the present invention will not influence the normal performance of the disc medium thereof (2).

Especially, by using the joining structure of the disc medium (2) and the multifunctional card (1), users will own more personal space to carry other items in addition to the combination. Besides, people also will no longer have disordered space.

It should be understood that different modifications and variations could be made from the teaching disclosed above by the people familiar in the art, without departing the spirit of the present invention.

What is claimed is:

1. A joining structure of a disc medium and a multifunctional card, comprising:
a disc medium with a thickness of 0.5-0.7 mm having a mounting hole with a diameter of 14.5-15.5 mm; and
a multifunctional card with a thickness of 0.2-0.4 mm joined with the disc medium and having a hole, the hole and the mounting hole are superposed at the center.

2. The joining structure of a disc medium and a multifunctional card as claimed in claim 1, wherein the hole is with a diameter larger than 15 mm.

3. The joining structure of a disc medium and a multifunctional card as claimed in claim 2, wherein an adhesive layer is further provided between the disc medium and the multifunctional card for secure adhesion of the disc medium and the multifunctional card.

4. The joining structure of a disc medium and a multifunctional card as claimed in claim 2, wherein the length of the diagonal line of the multifunctional card is equal to 120.5 mm or less.

5. The joining structure of a disc medium and a multifunctional card as claimed in claim 4, wherein an adhesive layer is provided further between the disc medium and the multifunctional card for secure adhesion of the disc medium and the multifunctional card.

6. The joining structure of a disc medium and a multifunctional card as claimed in claim 1, wherein the length of the diagonal line of the multifunctional card is equal to 120.5 mm or less.

7. The joining structure of a disc medium and a multifunctional card as claimed in claim 6, wherein an adhesive layer is provided further between the disc medium and the multifunctional card for secure adhesion of the disc medium and the multifunctional card.
